(19) United States
(12) Patent Application Publication
(10) Pub. No.: US 2014/0324506 A1
(43) Pub. Date: Oct. 30, 2014

(54) SYSTEMS AND METHODS FOR ESTIMATING RELIABILITY RETURN ON UTILITY VEGETATION MANAGEMENT

(71) Applicant: GENERAL ELECTRIC COMPANY, Schenectady, NY (US)

(72) Inventors: Jonathan Tompkins Garrity, Atlanta, GA (US); Hua Fan, Norcross, GA (US)

(73) Assignee: General Electric Company, Schenectady, NY (US)

(21) Appl. No.: 13/874,149

(22) Filed: Apr. 30, 2013

(51) Int. Cl. G06Q 10/10

(52) U.S. Cl. CPC G06Q 10/1097
USPC 705/7.21

(57) ABSTRACT

A system includes a utility analytics system. The utility analytics system includes a memory configured to store a vegetation management efficiency derivation system related to investment in vegetation management and a trim cycle derivation system related to management of vegetation associated with a power grid. The utility analytics system includes a processor communicatively coupled to the memory and configured to utilize the vegetation management efficiency derivation system and the trim cycle derivation system to derive a reliability return value on an investment to manage the vegetation associated with the power grid and to derive a trim cycle for the vegetation associated with the power grid based at least in part on the derived reliability return value. The trim cycle includes an output indicative of a frequency at which the vegetation associated with the power grid is managed.

### BACKGROUND

The invention relates generally to energy delivery infrastructure, and more specifically to methods and systems for estimating reliability return on vegetation management of the energy delivery infrastructure.

Certain energy infrastructure, such as electric power transmission and distribution grids, may include a variety of systems and components with sensors and detection devices to detect and analyze energy data. In the energy grid example, systems may include power generation systems, power transmission systems, power distribution systems, smart meters, digital communications systems, control systems, and their related components. Generally, the energy infrastructure may be constructed in forested, indeciduous, or other vegetational areas or locations. Thus, in addition to maintaining the energy infrastructure, the utility and/or utility service provider may also manage and/or monitor vegetation growth. It may be useful to provide methods to improve utility vegetation management.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

A system includes a utility analytics system. The utility analytics system includes a memory configured to store a vegetation management efficiency derivation system related to investment in vegetation management and a trim cycle derivation system related to management of vegetation associated with a power grid. The utility analytics system includes a processor communicatively coupled to the memory and configured to utilize the vegetation management efficiency derivation system and the trim cycle derivation system to derive a reliability return value on an investment to manage the vegetation associated with the power grid and to derive a trim cycle for the vegetation associated with the power grid based at least in part on the derived reliability return value. The trim cycle includes an output indicative of a frequency at which the vegetation associated with the power grid is managed.

A non-transitory computer-readable medium having code stored thereon, the code includes instructions to derive a reliability return value on an investment to manage vegetation associated with a power grid, and to derive a trim cycle for the vegetation associated with the power grid based at least in part on the derived reliability return value. The trim cycle includes an output indicative of a frequency at which the vegetation associated with the power grid is managed.

A method includes receiving, at a utility analytics system, power service outage data corresponding to a power outage on an electric power grid caused by vegetation associated with the electric power grid, calculating, via the utility analytics system, a total outage time based on the power service outage data as an indication of a reliability of the electric power grid, calculating, via the utility analytics system, a reliability return on an investment to manage the vegetation associated with the electric power grid, and calculating, via the utility analytics system, a trim cycle for the vegetation associated with the electric power grid based at least in part on the reliability return. The trim cycle includes an output indicative of a frequency at which the vegetation associated with the electric power grid is managed.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a energy generation, transmission, and distribution infrastructure system;

FIG. 2 is a block diagram of an embodiment of a utility analytics system included in the system of FIG. 1, in accordance with present embodiments; and

FIG. 3 is a flowchart illustrating an embodiment of a process suitable for estimating reliability return on vegetation management and calculating a corresponding trim cycle, in accordance with present embodiments.

### DETAILED DESCRIPTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Energy infrastructure, such as electric power transmission and distribution grids, may include a variety of systems and components used to generate, transmit, and distribute electric power to end users. For example, systems may include power generation systems, power transmission systems, power distribution systems, smart meters, digital communications systems, control systems, and their related components. Generally, the energy infrastructure may be constructed in forested, indeciduous, or other vegetational areas or locations. Thus, the utility and/or utility service provider maintaining the energy infrastructure may also manage the vegetation surrounding the energy infrastructure by regularly trimming, cutting, or removing the vegetation, as the vegetation may contribute to certain interruptions in power service to the end users. Unfortunately, the frequency at which vegetation is managed (e.g., trimmed, cut, removed, and so forth) by the utility may be based on tribal knowledge and/or empirical evidence, which may often lead to an inefficient management of the utility's resources.

Accordingly, present embodiments relate to systems and methods useful in estimating reliability return on vegetation management of electric power transmission grids, distribution substations and grids, and so forth, and calculating a vegetation management cycle (e.g., trim cycle) for which the reliability return may be increased. Particularly, a utility analytics system may include a vegetation management efficiency derivation system used to derive a reliability return on investment in vegetation management of the electric power transmission grid, distribution substations, service feeders, and/or service subfeeders. The utility analytics system may also include a trim cycle derivation system used to derive a trim cycle for vegetation management based on the derived reliability return. As used herein, “trim cycle” may refer to the frequency (e.g., the number of trims per time period) at which one or more vegetation operations (e.g., vegetation trims, vegetation cuts, vegetation removals) are performed for a given portion (e.g., transmission lines, distribution system service feeder, laterals of a particular distribution service feeder, and so forth) of an energy infrastructure or delivery system. Similarly, “reliability return” may refer to an improvement in reliability achieved per additional unit of currency (e.g. dollar) invested. Likewise, a “power outage” may refer to an interruption of electric power service or other utility service delivered to consumers by a utility and/or other utility service provider. It is to be noted that the techniques described herein may not be limited to electric power utilities, but may also be extended to any utility, including gas utilities, water utilities, sewage removal, and the like. For example, the present embodiments may be applied to calculate a cycle for which a utility and/or utility service provider checks gas and/or water infrastructure for possible leaks.

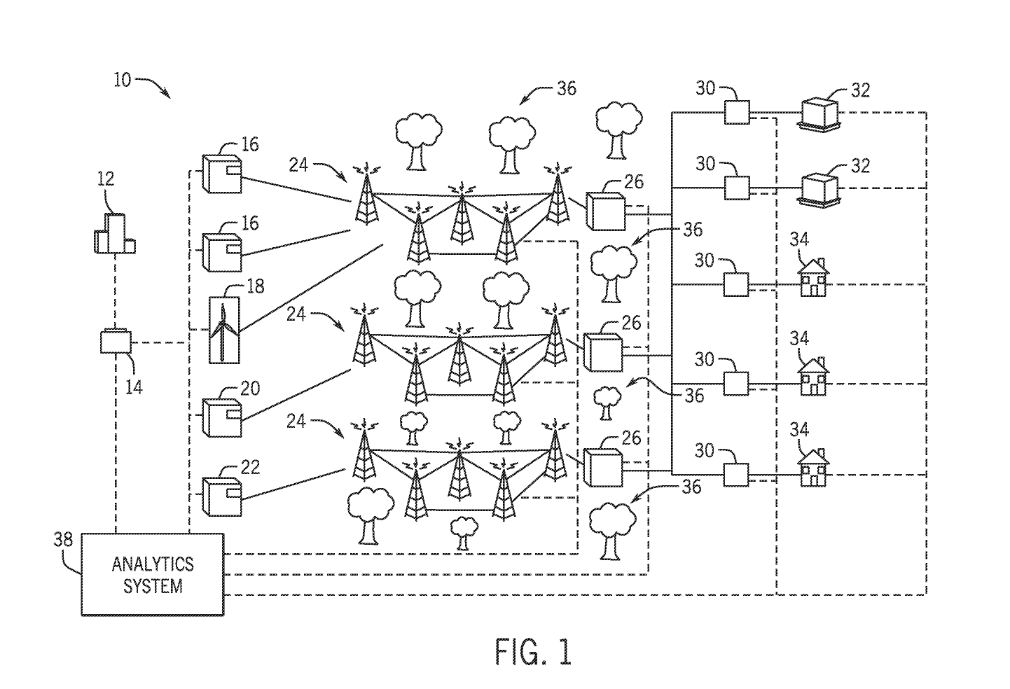

With the foregoing in mind, it may be useful to describe an embodiment of an energy infrastructure, such as an example power grid system 10 illustrated in FIG. 1. As depicted, the power grid system 10 may include one or more utilities 12. The utility 12 may provide for oversight operations of the power grid system 10. For example, utility control centers 14 may monitor and direct power produced by one or more power generation stations 16 and alternative power generation stations 18. The power generation stations 16 may include conventional power generation stations, such as power generation stations using gas, coal, biomass, and other carbonaceous products for fuel. The alternative power generation stations 18 may include power generation stations using solar power, wind power, hydroelectric power, geothermal power, and other alternative sources of power (e.g., renewable energy) to produce electricity. Other infrastructure components may include a water power producing plant 20 and geothermal power producing plant 22. For example, water power producing plants 20 may provide for hydroelectric power generation, and geothermal power producing plants 22 may provide for geothermal power generation.

The power generated by the power generation stations 16, 18, 20, and 22 may be transmitted via a power transmission grid 24. The power transmission grid 24 may cover a broad geographic region or regions, such as one or more municipalities, states, or countries. The transmission grid 24 may also be a single phase alternating current (AC) system, but most generally may be a three-phase AC current system. As depicted, the power transmission grid 24 may include a series of towers to support a series of overhead electrical conductors in various configurations. For example, extreme high voltage (EHV) conductors may be arranged in a three conductor bundle, having a conductor for each of three phases. The power transmission grid 24 may support nominal system voltages in the ranges of 110 kilovolts (kV) to 765 kilovolts (kV) or more. In the depicted embodiment, the power transmission grid 24 may be electrically coupled to a power distribution substation and grid 26. The power distribution substation and grid 26 may include transformers to transform the voltage of the incoming power from a transmission voltage (e.g., 765 kV, 500 kV, 345 kV, or 138 kV) to primary (e.g., 13.8 kV or 4154V) and secondary (e.g., 480V, 240V, or 120V) distribution voltages. For example, industrial electric power consumers (e.g., production plants) may use a primary distribution voltage of 13.8 kV, while power delivered to commercial and residential consumers may be in the secondary distribution voltage range of 120V to 480V. Furthermore, the power distribution substation and grid 26 may include a system of distribution service feeders (e.g., three-phase and/or single-phase electric power mains connected to the secondary side of the substation to deliver to consumers of a particular geographical region) and a series of laterals (e.g., single-phase service subfeeders delivering power to consumers of a particular neighborhood, subdivision, or other sub region).

As again depicted in FIG. 1, the power transmission grid 24 and power distribution substation and grid 26 may be part of the power grid system 10. Accordingly, the power transmission grid 24 and power distribution substation and grid 26 may include various digital and automated technologies to control power electronic equipment such as generators, switches, circuit breakers, reclosers, and so forth. The power transmission grid 24 and power distribution substation and grid 26 may also include various communications, monitoring, and recording devices such as, for example, programmable logic controllers (PLCs), intelligent electronic devices (IEDs), digital fault recorders (DFRs), digital protective relays (DPRs), and so forth. In certain embodiments, voltage and current real-time data (e.g., electrical fault events) may be recorded at the power transmission grid 24 and communicated to the utility control center 14.

In certain embodiments, a meter 30 may be an Advanced Metering Infrastructure (AMI) meter used to collect, measure, and analyze electric power usage and/or generation. For example, electric utilities may report to consumers their usage and/or generation per kilowatt-hour (kWh) for billing and/or crediting purposes. The meter 30 may be electrically and communicatively coupled to one or more of the components of the system 10, including the power transmission grids 24, power distribution substation and grid 26, and a commercial and/or industrial consumer 32 and residential consumer 34. Additionally, the meter 30 may enable two-way communication between commercial sites 32, residences 34, and the utility control center 14, providing for a link between consumer behavior and electric power usage and/or generation. For example, the meter 30 may track and account for pre-paid energy usage and/or energy used before payment As noted above, electric power may also be generated by the consumers (e.g., commercial consumers 32, residential consumers 34). For example, the consumers 32, 34 may interconnect a distributed generation (DG) resource (e.g., solar panels or wind turbines) to generate and deliver power to the grid 26.

As further illustrated in certain embodiments, the transmission grid 24 and/or distribution substation and grid 26 may be surrounded or constructed nearby vegetation 36. The vegetation 36 may include, for example, trees, shrubs, bushes, undergrowth, or other plant life that may interfere with, or create a disturbance (e.g., electrical fault) on the transmission grid 24 and/or distribution substation and grid 26, and by extension, an interruption of the electric power service delivered to the consumers 32 and 34. For example, during storms (e.g., thunderstorms, windstorms) or on gusty days, the vegetation 36 may blow into, or otherwise fall upon one or more transmission lines of the transmission grid 24 and/or service feeders or service subfeeders of the distribution substation and grid 26. This may create an electrical fault (line-to-ground fault, double line-to-ground fault, and so forth) on the transmission grid 24 and/or distribution substation and grid 26. Such electrical faults may lead to both temporary and/or permanent power outages experienced by the consumers 32 and 34. Therefore, the utility 12 and/or other utility service provider may deploy servicemen to regularly trim, cut, or completely removed the vegetation 36, for example, to increase reliability of the transmission grid 24 and/or distribution substation and grid 26. However, the frequency at which the vegetation 36 is managed (e.g., trimmed, cut, removed, and so forth) may be based on tribal knowledge, or other empirical data. For example, the utility 12 may manage the vegetation 36 according to a monthly or annually schedule, or after a physical observation is made of the vegetation 36. However, such methods of vegetation management may often result in an inefficient management of resources (e.g., capital investment, man-hours, and so forth) of the utility 12.

Accordingly, it may be useful to provide a utility analytics system 38 to be used, for example, by an operator of the utility control center 14 for data collection, control, and operation of one or more components (e.g., transmission grid 24, distribution substation and grid 26, meters 30, and so forth) of the system 10. In certain embodiments, the utility analytics system 38 may be any hardware system, software system, or a combination thereof, suitable for analyzing, deriving, and/or modeling energy delivery data, business data, and/or vegetation management data relating to the system 10. For example, as will be discussed in further detail below, the utility analytics system 38 may include an Advanced Analytics and Visualization Framework (AAVF) and may include various subsystems (e.g., software systems implemented as computer executable instructions stored in a non-transitory machine readable medium such as memory, a hard disk drive, or other short term and/or long term storage) that may be used to derive and calculate business and/or operational related parameters such as the utility 12 return on investment (ROI) of vegetation 36 management, overall system reliability of the transmission grid 24 and/or distribution substation and grid 26, expected expenditure savings of the utility 12, a vegetation 36 trim cycle model based on reliability ROI, and so forth. Accordingly, the utility analytics system 38 may receive inputs from the power generation stations 16, 18, 20, and 22, the transmission grid 24, the substation and grid 26, the meters 30, and so forth, and present such information to, for example, an operator of the utility control center 14.

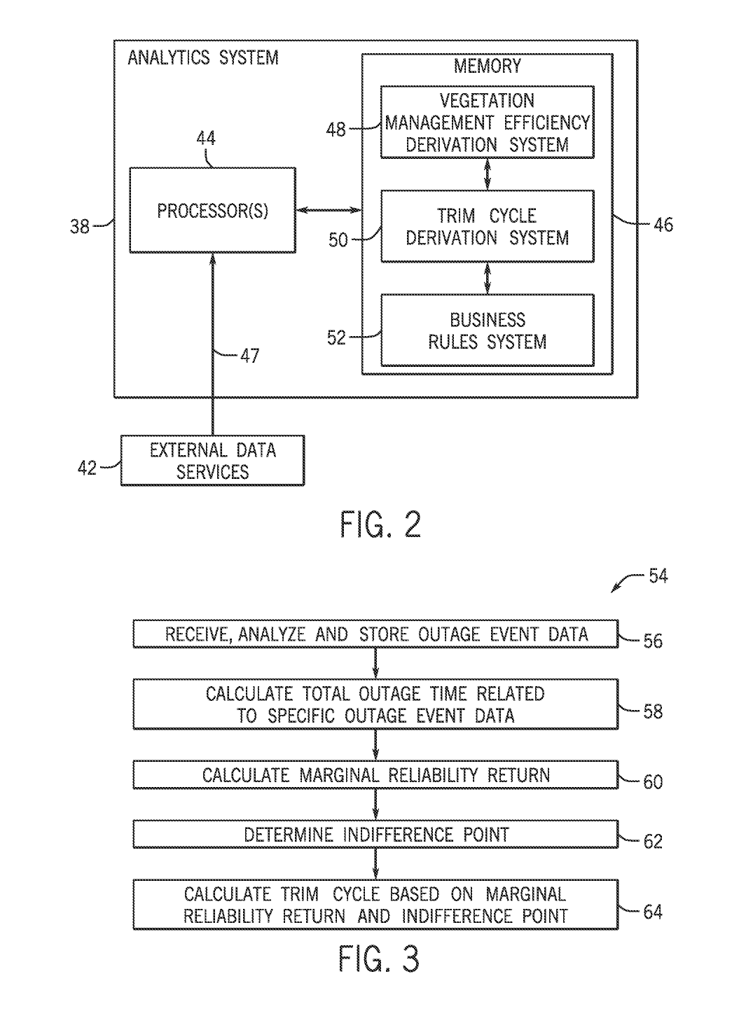

FIG. 2 is a block diagram of an embodiment of the utility analytics system 38. As illustrated, the utility analytics system 38 may include one or more processors 44, a memory 46 (e.g., storage), input/output (I/O) ports (e.g., one or more network interfaces 47), an operating system, software applications, and so forth, useful in implementing the techniques described herein. Particularly, the utility analytics system 38 may include code or instructions stored in a non-transitory machine-readable medium (e.g., the memory 46 and/or storage) and executed, for example, by the one or more processors 44 that may be included in the analytics system 38. Additionally, the utility analytics system 38 may include a network interface 47, which may allow communication within the system 10 via a personal area network (PAN) (e.g., NFC), a local area network (LAN) (e.g., Wi-Fi), a wide area network (WAN) (e.g., 3G or LTE), a physical connection (e.g., an Ethernet connection, power line communication (PLC)), and/or the like. In certain embodiments, the utility analytics system 38 maybe used to estimate a ROI of vegetation 36 management and derive a vegetation 36 trim cycle model based on the ROI.

As depicted, the utility analytics system 38 may receive data from external data services 42 communicatively coupled to the one or more processors 44 of the utility analytics system 38. The one or more processors 44 may transfer the received data between systems of the memory 46 internal to the utility analytics system 38. This data may include energy and business-related data, which in some embodiments, may be derived and/or calculated based on data received from the transmission grid 24, distribution substation and grid 26, meters 30, and so forth. The external data services 42 may include systems useful in exchanging data with components (e.g., generation stations 16, 18, 20, and 22, grids 24 and 26, meter 30, and so forth) external to the analytics system 38.

For example, in certain embodiments, the utility analytics system 38 may received external data from an Outage Management System (OMS) that may detect and respond to outage or interruption events such as, for example, temporary and/or permanent electrical faults (e.g., line-to-ground faults, double line-to ground faults, and so forth) on the grid 24 and/or grid 26 possibly caused by the vegetation 36. In certain embodiments, the utility analytics system 38 may use the data received via the OMS to predict power outages and/or power service interruptions (e.g., electrical faults) caused by the vegetation 36. Thus, the utility analytics system 38 may use probabilistic techniques, such as statistical methods (e.g., linear regression, non-linear regression, ridge regression, data mining) and/or artificial intelligence models (e.g., expert systems, fuzzy logic, support vector machines [SVMs], logic reasoning systems) to generate historical and/or predictive power outage event data, which may be used to distinguish between, for example, vegetation 36-caused power outages and those caused by lightning strikes, animals, equipment failures, and so forth.

Similarly, the utility analytics system 38 may receive external data from a Distribution Management System (DMS) suitable for re-routing energy from plants 16, 18, 20, and 22 experiencing lesser demand and away to plants 16, 18, 20, and 22 experiencing greater demand. The external data services 42 may also include a Geographic Information System (GIS) that may be used to provide physical location information of (e.g., location information regarding specific distribution service feeders and the vegetation 36 nearby or surrounding such service feeders) of grids 24 and 26 to the utility analytics system 28. The physical location information may be used, for example, to create vegetation 36 trim cycle visualizations to display on a map or other suitable visual medium (e.g. chart) presented to, for example, an operator of the utility control center 14.

Still similarly, the utility analytics system 38 may further receive external data from a Customer Information System (CIS) to obtain customer information (e.g., consumers 32, 34), including billing information, energy usage information, load profiles, the number of outages and the duration of each outage experienced by the consumers 32, 34, and the like. In other embodiments, the external data services 42 may include a Meter Data Management (MDM) system useful in management of large quantities of energy data that may be received, for example, from the meters 30. Such data may primarily include usage data, events data (e.g., power service interruptions), alarms, and/or alerts that are received from the meter 30 via AMI or Automatic Meter Reading (AMR) systems. Yet still, the utility analytics system 38 may receive external data from a Meter Data Repository (MDR) which calculates the amount of electricity used by the consumers 32, 34, for example, during peak, near-peak, and off-peak hours, which may be a further indicator of the impact to reliability of vegetation 36-caused outages. The utility analytics system 38 may also receive and utilize data from external data services 42 such as weather prediction systems (e.g., Global Forecast System, Doppler radars, and the like), satellites (e.g., meteorological satellites useful in providing Normalized Difference Vegetation Index (NDVI) data), LIDAR and/or LADAR systems, and so forth. As will be further appreciated, the data received via the OMS, DMS, GIS, CIS, MDM, MDR, AMI, and weather prediction systems maybe input to internal systems of the utility analytics system 38, such as a vegetation management efficiency derivation system 48 and a trim cycle derivation system 50 stored, for example, in the memory 46 of the utility analytics system 38.

In certain embodiments, the vegetation management efficiency derivation system 48 may be a software system and/or a combination of software and hardware, that may be used to derive and/or calculate the ROI of vegetation management (e.g., management of vegetation 36) per distribution service feeder of the distribution substation and grid 26. However, in other embodiments, the vegetation management efficiency derivation system 48 may derive and/or calculate the ROI of vegetation management per transmission line of the transmission grid 24, per substation of the distribution substation and grid 26, and/or per lateral (e.g., service subfeeders in which individual consumers 32, 34 of a particular sub-region may be delivered electric power). Particularly, the vegetation management efficiency derivation system 48 may derive and/or calculate the efficacy (e.g., effectiveness) of vegetation 36 management investments per service feeder. That is, the vegetation management efficiency derivation system 48 may derive and/or calculate the marginal reliability return (e.g., in time per consumer 32, 34 power outage possibly due to the vegetation 36) for each of a number of distribution service feeders of the distribution substation and grid 26.

For example, the vegetation management efficiency derivation system 48 may define a given vegetation 36-caused power outage variable i, a service feeder variable ƒ (e.g., distribution service feeders of the distribution substation and grid 26), a power outage duration variable D_{i, ƒ} (e.g., the period of time the consumers 32, 34 may experience the vegetation 36-caused power outage) and the number of consumers 32, 34 of the service feeder ƒ affected by the vegetation 36-caused power outage i variable C_{i, ƒ}. As previously noted, the aforementioned variables (e.g., power outage i, service feeder ƒ, duration D_{i, ƒ}, and consumers 32, 34 affected C_{i, ƒ}) may be received by the utility analytics system 38 and/or derived by the utility analytics system 38 based on a knowledgebase derived from data received via OMS, DMS, GIS, CIS, MDM, MDR, and AMI systems and/or data (e.g., real-time) received from the transmission grid 24, the distribution substation and grid 26, the meters 30, and so forth.

Continuing, an aggregate spending variable S_{ƒ}, representing an aggregate of an annual expenditure on vegetation 36 management on the service feeder ƒ, may also be defined by the vegetation management efficiency derivation system 48. For example, the variable S_{ƒ} may represent an aggregate of the total amount of resources (e.g., man-hours, financial expenditures, and so forth) expended by the utility 12 in a given year on vegetation 36 management (e.g., trimming, cutting, or removing the vegetation 36) with respect to the service feeder ƒ.

For over a given year and for a given service feeder ƒ the total power outage time (e.g., total number of minutes or hours of a vegetation 36-caused power outage i experienced by approximately all of the consumers 32, 34 delivered power by the service feeder ƒ) may be approximated by the vegetation management efficiency derivation system 48 as:

R_{f}=D_{i,f}·C_{i,f} equation (1).

Accordingly, considering equation (1), the reliability per unit of currency invested (e.g., per dollar invested) in vegetation 36 management by the utility 12 may be written as:

$$Reliability Per Unit Investment in Vegetation Management = \frac{{R}_{f}}{{S}_{f}} . \qquad equation ( 2 )$$

That is,

$$\frac{{R}_{f}}{{S}_{f}}$$

may represent the total power outage time (e.g., in number of seconds, minutes, hours, and so forth) R_{ƒ} divided by the aggregate vegetation 36 management spending by the utility 12 on the service feeder ƒ over a given year, S_{ƒ}. Based on the aforementioned derived data, the vegetation management efficiency derivation system 48 may then compare

$$\frac{{R}_{f}}{{S}_{f}}$$

for n number of years (e.g.,

$$\frac{{R}_{f 1}}{{S}_{f 1}} , \frac{{R}_{f 2}}{{S}_{f 2}} , … , \frac{{R}_{fn}}{{S}_{fn}} )$$

to derive a marginal reliability return:

$${MU}_{f} ∼ \frac{\partial }{\partial t} \frac{{R}_{f}}{{S}_{f}} . \qquad equation ( 3 )$$

In the above-illustrated equation (3), MU_{ƒ} may, for example, represent a marginal reliability return for the utility 12. In other words, for each additional unit of currency (e.g., dollar) invested in vegetation 36 management of the service feeder ƒ by the utility 12, for example, the utility 12 may expect a marginal reliability return of MU_{ƒ} (e.g., in time per consumer 32, 34 power outage possibly due to the vegetation 36) for the given service feeder ƒ. However, in certain embodiments, the vegetation management efficiency derivation system 48 may derive and/or calculate the marginal reliability return of MU_{ƒ} according to certain criteria or predetermined rules (e.g., one or more business rules) generated by a business rules system 52 that may be included in the utility analytics system 38. The business rules system 52 may be any system (e.g., software system and/or software application) useful in generating one or more business rules including, for example, financial goals, company policies, legal regulations, and/or similar business operations data.

For example, in certain embodiments, the business rules system 52 may generate a target reliability and/or target ROI for the utility 12 that may be used by the vegetation management efficiency derivation system 48 to derive and/or calculate a marginal reliability return MU_{ƒ} equal to the target reliability and/or target ROI. Furthermore, as will be further appreciated, the business rules system 52 may define an indifference point I with respect to vegetation 36 management based on the target reliability and/or target ROI, in which the indifference point I may represent approximately the smallest improvement in reliability (e.g., reliability of a service feeder ƒ of the distribution substation and grid 26) acceptable by the utility 12 for each additional unit of currency (e.g., dollar) invested in vegetation 36 management for the given service feeder ƒ. The marginal reliability return of MU_{ƒ} and the indifference point I may be used by the trim cycle derivation system 50 to derive improved trim cycles for the given service feeder ƒ that may maximize ROI for utility 12.

In further illustration of the foregoing, similar to the vegetation management efficiency derivation system 48, the trim cycle derivation system 50 may be a software system and/or a combination of software and hardware, which may be used to derive and/or calculate improved and more efficient trim cycles (e.g., the frequency at which the one or more vegetation 36 trims, cuts, and/or removals are performed for a given service feeder ƒ). For example, as noted above, the business rules system 52 may define an indifference point I with respect to vegetation 36 management and the marginal reliability return of MU_{ƒ} derived, for example, by the vegetation management efficiency derivation system 48.

Specifically, the business rules system 52 may define that for all MU_{ƒ}>I, the ROI for the feeder ƒ is sufficient, and that for all MU_{ƒ}<I, the ROI for the feeder f is insufficient. Accordingly, to maximize reliability return (e.g., the reliability ROI for vegetation 36 management by the utility 12), in certain embodiments, the trim cycle derivation system 50 may derive and/or calculate a trim cycle (Tₙ) for which the marginal reliability return MU_{ƒ} is substantially equal to the indifference point I (e.g., MU_{ƒ}=I). Specifically, as previously discussed, the trim cycle Tₙ may be the frequency at which one or more vegetation 36 management operations (e.g., vegetation 36 trims, vegetation 36 cuts, vegetation 36 removals, and so forth) are performed for a given service feeder ƒ, in which n may represent the number of years between vegetation 36 management operations performed by, for example, the utility 12. As n (e.g., number of years) may be inversely proportional to the average cost (e.g., average capital expenditure by the utility 12 for vegetation 36 management) per year for the given service feeder ƒ, the trim cycle derivation system 50 may be used to compare the marginal reliability return MU_{ƒ} to the indifference point I, and to derive and/or calculate n such that the marginal reliability return MU_{ƒ} is substantially equal to the indifference point I.

In certain embodiments, the trim cycle derivation system 50 may derive a distribution of the reliability ROI across service feeders ƒ of, for example, the distribution substation and grid 26 based on the marginal reliability return MU_{ƒ} for each service feeder ƒ. In order to determine n (e.g., number of years between vegetation 36 management operations) for each service feeder ƒ such that MU_{ƒ}=I, the trim cycle derivation system 50 may derive a function of the number of years n between vegetation 36 management operations as:

n=f(MU_{ƒ},Θ) equation (4).

In the above-illustrated equation (4), the function ƒ(MU_{ƒ},Θ) may be an increasing function in MU_{ƒ} for all MU_{ƒ}<I (e.g., reliability ROI is less than the indifference point). That is, for all distribution service feeders ƒ having an MU_{ƒ}<I, the trim cycle derivation system 50 may adjust the trim cycle Tₙ by increasing n (e.g., decreasing the number of years between management operations for the service feeder ƒ). Similarly, the function ƒ(MU_{ƒ},Θ) may be a decreasing function in MU_{ƒ} for all MU_{ƒ}>I. As such, for all distribution service feeders ƒ having an MU_{ƒ}>I, the trim cycle derivation system 50 may adjust the trim cycle Tₙ by decreasing n (e.g., decreasing the number of years between vegetation 36 management operations for the service feeder ƒ). Specifically, the trim cycle derivation system 50 may generate n based on the absolute distance between the marginal reliability return MU_{ƒ} and the indifference point I to achieve a marginal reliability return MU_{ƒ} that is substantially equal to the indifference point I.

In this manner, the utility 12 may have a calculated value for ROI of vegetation 36 management for the given service feeder ƒ, thus allowing the utility 12, for example, to make more informed business determinations on matters such as increasing and/or reducing vegetation (e.g., vegetation 36) trim cycles for certain distribution service feeders, management of resources (e.g., financial resources and man-hours), and business planning according to the expected ROI for vegetation management. More particularly, a specific marginal reliability return MU_{ƒ} and trim cycle Tₙ may be generated for each service feeder ƒ, such that the utility 12 may be allowed to compare the reliability benefit to the vegetation management marginal cost.

As also illustrated by equation (4), the trim cycle derivation system 50 may further define a set of future state variables Θ. In certain embodiments, the set of future state variables Θ may represent certain data about one or more future states of the given service feeder ƒ that may impact the marginal reliability return MU_{ƒ}. For example, the set of future state variables Θ may include impacts on vegetation 36 management in future years such as the impacts of natural deforestation, droughts, deciduousness, and so forth.

Turning now to FIG. 3, a flow diagram is presented, illustrating an embodiment of a process 54 useful in estimating reliability return on vegetation management and calculating a trim cycle, by using, for example, the utility analytics system 38 included in the system 10 depicted in FIG. 1. The process 54 may include code or instructions stored in a non-transitory machine-readable medium (e.g., the memory 46) and executed, for example, by the one or more processors 44 included in the analytics system 38. The process 54 may begin with the utility analytics system 38 receiving, analyzing, and storing (block 56) power outage event data. For example, as previously discussed, the utility analytics system 38 may receive and/or derive power outage data (e.g., vegetation-caused power outage data) based on data received via an OMS or similar system. Other data may also be received, analyzed, and stored including, for example, energy utilization data, business-related data, weather and/or meteorology related data, regulatory data, and so on received, for example, via the external data services 42. The process 54 may continue with the utility analytics system 38 calculating (block 58) a total outage time related to specific outage event data (e.g., vegetation-caused outage data) experience by all consumers (e.g., consumers 32, 34) delivered power by a given distribution service feeder over, for example, a given year. The total outage time (e.g., total outage seconds, minutes, hours) may be an indication of the reliability of the given service feeder.

The process 54 may then continue with the utility analytics system 38 calculating (block 60) a marginal reliability return for the given service feeder. That is, the utility analytics system 38 may calculate, for each additional unit of currency (e.g., dollar) invested in vegetation management of the given service feeder by the utility 12, the expected marginal reliability return (e.g., marginal reliability return MU_{ƒ}). The marginal reliability return may be expressed in terms of time (e.g., minutes, hours) per consumer 32, 34 power outage possibly due to vegetation 36 interference with the given service feeder. The utility analytics system 38 may then determine an indifference point (e.g., indifference point I generated by the business rules system 52), in which the indifference point may represent approximately the smallest improvement in reliability acceptable by the utility 12 for each additional unit of currency (e.g., dollar) invested in management of the vegetation 36 with respect to the given service feeder.

Based upon the marginal reliability return calculation (e.g., block 60) and the indifference point determination (e.g., block 62), the process 54 may conclude with the utility analytics system 38 calculating (block 64) a trim cycle (e.g., the frequency at which one or more vegetation 36 trims, cuts, and/or removals are performed) for the given service feeder. Particularly, the utility analytics system 38 may calculate a trim cycle (e.g., Tₙ) for which the marginal reliability return (e.g., block 60) is substantially equal to the indifference point (e.g., block 62). To do so, the utility analytics system 38 may calculate an n number of years between vegetation management operations of the given service feeders. As previously noted, in this manner, the utility 12 may have a calculated value for the ROI of the management of vegetation for the given service feeder, thus allowing the utility 12, for example, to make more informed business determinations on matters such as increasing and/or reducing vegetation (e.g., vegetation 36) trim cycles for certain distribution service feeders, management of resources (e.g., financial resources and man-hours), and business planning according to the expected ROI for vegetation management. More particularly, a specific marginal reliability return (e.g., MU_{ƒ}) and trim cycle (e.g., Tₙ) may be generated for each service feeder, such that the utility 12 may be allowed to compare the reliability benefit to the vegetation management marginal cost and to determine a trim cycle for each service feeder based on the comparison analysis.

Technical effects of the disclosed embodiments include systems and methods to estimate reliability return on vegetation management of electric power transmission grids, distribution substations and grids, and so forth, and calculate a vegetation management cycle (e.g., trim cycle) for which the reliability return is maximized. Particularly, a utility analytics system may include a vegetation management efficiency derivation system used to derive a reliability return on investment in vegetation management of the electric power transmission grids, distribution substations service feeders, service subfeeders, and so forth. The utility analytics system may also include a trim cycle derivation system used to derive a trim cycle for vegetation management based on the derived reliability return.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a utility analytics system, comprising:
a memory configured to store a vegetation management efficiency derivation system related to investment in vegetation management and a trim cycle derivation system related to management of vegetation associated with a power grid; and
a processor communicatively coupled to the memory and configured to utilize the vegetation management efficiency derivation system and the trim cycle derivation system to:
derive a reliability return value on an investment to manage the vegetation associated with the power grid; and
derive a trim cycle for the vegetation associated with the power grid based at least in part on the derived reliability return value, wherein the trim cycle comprises an output indicative of a frequency at which the vegetation associated with the power grid is managed.

2. The system of claim 1, wherein the processor is configured to derive the reliability return value on the investment for each of a plurality of service feeders of the power grid.

3. The system of claim 2, wherein the reliability return value comprises a marginal reliability return based at least in part on:
a calculated reliability for one of the plurality of service feeders; and
an annual expenditure on management of the vegetation associated with the one of the plurality of service feeders.

4. The system of claim 1, wherein the memory is configured to store a business rules system, and wherein the processor is configured to utilize the business rules system to derive an indifference point with respect to the investment.

5. The system of claim 4, wherein the processor is configured to use the indifference point to derive the trim cycle, and wherein the indifference point comprises a threshold value to which the reliability return value is compared.

6. The system of claim 4, wherein the processor is configured to derive the trim cycle such that the reliability return value is substantially equal to the indifference point.

7. The system of claim 1, wherein the processor is configured to derive the trim cycle by:
comparing the reliability return value to an indifference point with respect to the investment to manage vegetation associated with a service feeder of the power grid; and
calculating the trim cycle for the vegetation associated with the service feeder based at least in part on whether the reliability return value is below or above the indifference point, wherein calculating the trim cycle comprises calculating a period between actions to manage the vegetation associated with the service feeder such that the reliability return value is substantially equal to the indifference point.

8. The system of claim 1, wherein the processor is configured to derive a plurality of trim cycles, wherein each trim cycle corresponds to vegetation associated with a different one of a plurality of service feeders of the power grid.

9. The system of claim 1, wherein the management of the vegetation associated with the power grid comprises a trimming, a cutting, a removal, or a combination thereof, of vegetation substantially surrounding or nearby one or more service feeders of the power grid.

10. The system of claim 1, wherein the utility analytics system comprises an Advanced Analytics and Visualization Framework (AAVF), and wherein the utility analytics system is configured to receive an indication from an Outage Management System (OMS), a Distribution Management System (DMS), a Geographic Information System (GIS), a Customer Information System (CIS), an Advanced Metering Infrastructure (AMI), a Meter Data Management System (MDM), a Meter Data Repository (MDR), or any combination thereof.

11. A non-transitory computer-readable medium having computer executable code stored thereon, the code comprising instructions to:
derive a reliability return value on an investment to manage vegetation associated with a power grid; and
derive a trim cycle for the vegetation associated with the power grid based at least in part on the derived reliability return value, wherein the trim cycle comprises an output indicative of a frequency at which the vegetation associated with the power grid is managed.

12. The non-transitory computer-readable medium of claim 11, wherein the code comprises instructions to derive the reliability return value on the investment for each of a plurality of service feeders of the power grid.

13. The non-transitory computer-readable medium of claim 11, wherein the code comprises instructions to derive the reliability return value by calculating a marginal reliability return based at least in part on:
a calculated reliability for one of the plurality of service feeders; and
an annual expenditure on management of the vegetation associated with the one of the plurality of service feeders.

14. The non-transitory computer-readable medium of claim 11, wherein the code comprises instructions to use at least one business rule to derive the trim cycle, and wherein the at least one business rule comprises an indifference point to which the reliability return value is compared.

15. The non-transitory computer-readable medium of claim 14, wherein the code comprises instructions to derive the trim cycle such that the reliability return value is substantially equal to the indifference point.

16. The non-transitory computer-readable medium of claim 11, wherein the code comprises instructions to:
compare the reliability return value to an indifference point with respect to the investment to manage vegetation associated with a service feeder of the power grid; and
calculate the trim cycle for the vegetation associated with the service feeder based at least in part on whether the reliability return value is below or above the indifference point, wherein calculating the trim cycle comprises calculating a period between actions to manage the vegetation associated with the service feeder such that the reliability return value is substantially equal to the indifference point.

17. A method, comprising:
receiving, at a utility analytics system, power service outage data corresponding to a power outage on an electric power grid caused by vegetation associated with the electric power grid;
calculating, via the utility analytics system, a total outage time based on the power service outage data as an indication of a reliability of the electric power grid;
calculating, via the utility analytics system, a reliability return on an investment to manage the vegetation associated with the electric power grid; and
calculating, via the utility analytics system, a trim cycle for the vegetation associated with the electric power grid based at least in part on the reliability return, wherein the trim cycle comprises an output indicative of a frequency at which the vegetation associated with the electric power grid is managed.

18. The method of claim 17, wherein calculating the reliability return comprises calculating a marginal reliability return for each of a plurality of service feeders of the electric power grid, and wherein calculating the trim cycle comprises calculating a plurality of trim cycles, wherein each trim cycle of the plurality of trim cycles corresponds to a different one of the plurality of service feeders of the electric power grid.

19. The method of claim 17, comprising:
determining an indifference point with respect to the investment to manage the vegetation;
comparing the reliability return to the indifference point, and
calculating the trim cycle based at least in part on whether the reliability return is below or above the indifference point, wherein the trim cycle is configured to render the reliability return substantially equal to the indifference point.

20. The method of claim 17, comprising calculating the trim cycle by determining a period associated with the trim cycle, wherein the period comprises a set amount of time between one or more actions to manage the vegetation, and wherein the period is determined such that the reliability return substantially equals the indifference point.
